(19) United States
(12) Patent Application Publication
(10) Pub. No.: US 2016/0263568 A1
(43) Pub. Date: Sep. 15, 2016

(54) METHODS AND APPARATUS FOR REGENERATION OF CATALYST BEDS IN REACTORS

(71) Applicant: REPUBLIC CHEMICAL TECHNOLOGIES, HOUSTON, TX (US)

(72) Inventors: DAVID O. TRAHAN, LAFAYETTE, LA (US); RICHARD SAPIENZA, LAFAYETTE, LA (US); SRINIVASAN AMBATIPATI, LAFAYETTE, LA (US)

(73) Assignee: REPUBLIC CHEMICAL TECHNOLOGIES, HOUSTON, TX (US)

(21) Appl. No.: 15/069,506

(22) Filed: Mar. 14, 2016

Related U.S. Application Data
(60) Provisional application No. 62/132,757, filed on Mar. 13, 2015.

(51) Int. Cl. B01J 38/12; B01J 38/04

(52) U.S. Cl. CPC B01J 38/12; B01J 38/04

(57) ABSTRACT

The present invention relates to catalyst beds and, more particularly, regeneration of the catalyst by contacting the catalyst bed with nitrogen-rich gas, such as, air. The catalyst beds are typically positioned within a reactor vessel, such as, fixed-bed catalyst reactors. The catalyst bed serves as a solid support upon which chemical react. As a result of operation of the reactors, over a period of time, solid matter deposits on at least a portion of the catalyst bed causing reduced activity of the catalyst. Thus, the catalyst regeneration systems and methods of the invention provide the ability to provide continued effectiveness of the catalyst.

### CROSS-REFERENCE TO RELATED APPLICATIONS

This application claims priority under 35 U.S.C. §119(e) to U.S. Provisional Patent Application Ser. No. 62/132,757, filed Mar. 13, 2015, entitled METHODS AND APPARATUS FOR REGENERATION OF CATALYST BEDS IN REACTORS, which is herein incorporated by reference.

### FIELD OF THE INVENTION

The invention generally relates to catalyst beds, including fixed-bed catalyst reactors and, methods and apparatus for regenerating catalyst. The catalyst regeneration can be conducted in-place, e.g., integral to the system wherein the reactor is positioned, or off-site, e.g., in a separate or remote system or device.

### BACKGROUND OF THE INVENTION

Various types and designs of catalytic bed reactors are known in the art. In these reactors, the catalyst bed serves as a solid substrate upon which chemical species react. It is also known that the catalyst material can become less effective over time and therefore, regeneration is needed.

There is a desire in the art to develop methods and apparatus for regenerating catalyst beds in reactors, such as, fixed bed reactors, that is effective, simple and convenient. It certain systems, it may be advantageous for the regeneration to be capable of being conducted with the catalyst bed remaining in the reactor.

### SUMMARY OF THE INVENTION

It has been surprisingly found that catalyst bed regeneration can be accomplished by directing a stream of heated nitrogen-rich (oxygen-lean) gas, e.g., air, through or over the catalyst bed. The heated nitrogen-rich gas is effective to remove solid matter, e.g., carbon particles, deposited on the face or surface of the catalyst, and regenerate the catalyst.

Thus, in one aspect, the invention provides a method of regenerating a catalyst bed, wherein catalyst has solid matter deposited thereon. The method includes heating a nitrogen-rich gas to an elevated temperature to produce a heated nitrogen-rich gas, passing the heated nitrogen-rich gas through or over the catalyst bed and contacting the catalyst with the heated nitrogen-rich gas.

In certain embodiments, the nitrogen-rich gas is air.

The catalyst bed can be positioned within a reactor vessel and regenerating the catalyst can be conducted without removing the catalyst bed from the reactor vessel. In certain other embodiments, the catalyst bed is removed from the reactor vessel for regenerating the catalyst.

The solid matter deposited on the catalyst can be carbon particles, coke deposits, carbon-containing particles, and mixtures thereof

In another aspect, the invention provides a method of regenerating catalyst in a catalyst bed positioned in a reactor, wherein the catalyst has solid matter deposited thereon. The method includes introducing a heated nitrogen-rich gas at an inlet of the reactor, allowing the heated nitrogen-rich gas to flow through an interior of the reactor, contacting the catalyst in the catalyst bed of the reactor with the heated nitrogen-rich gas, and discharging the heated nitrogen-rich gas through an outlet of the reactor.

The nitrogen-rich gas can be heated to an elevated temperature prior to being introduced into the reactor. The method can further include dislodging at least a portion of the solid matter from the catalyst and subsequently, removing said at least a portion of the solid matter from the reactor.

In certain embodiments, the method can be conducted with the catalyst bed positioned in the reactor, e.g., without removing the catalyst from the reactor. In other embodiments, the regeneration of the catalyst is conducted outside of the reactor.

The reactor can be a fixed-bed catalyst reactor.

### BRIEF DESCRIPTION OF THE DRAWINGS

A full understanding of the invention can be gained from the following description of the preferred embodiments when read in conjunction with the accompanying drawing, in which:

FIG. 1 is a schematic showing a chemical system employing fixed-bed catalyst reactors.

### DETAILED DESCRIPTION OF THE INVENTION

The methods and apparatus of the invention relate to catalyst in a reactor vessel, such as, a catalyst bed in a fixed-bed catalyst reactor. In a catalyst bed, the catalyst serves as a solid support upon which chemical species react. In general, during operation of a reactor, solid matter, e.g., particulate, is generated in the reactor vessel and over a period of time the solid matter deposits on the catalyst. As a result, catalyst activity is reduced due to plugging of the catalyst pores with the solid matter. The solid matter can be in various forms. For example, the solid matter can include carbon particles, coke deposits and mixtures thereof. The carbon particles and/or coke deposits can enter pores of the catalyst and cause plugging, thereby reducing the effectiveness of the catalyst bed. To ensure continued effectiveness and reduced plugging, catalyst of the catalyst bed is regenerated.

In accordance with the invention, catalyst is regenerated by oxidizing the solid matter deposited thereon with an oxidizer. The oxidizer includes nitrogen-rich gas, such as, air. Air is a colorless, odorless gaseous mixture composed mainly of nitrogen (approximately 78 percent) and oxygen (approximately 21 percent) with lesser (minor) amounts of carbon dioxide, hydrogen and other gases. The oxidized solid matter transforms into a gas including nitrogen, water, carbon monoxide, carbon dioxide and mixtures thereof. For example, carbon burns to carbon dioxide and hydrogen burns to water. The amount of oxygen is controlled by nitrogen gas dilution, which controls the increase in temperature due to the oxidation of carbon and residual organics. Limiting the increase in temperature during regeneration of the catalyst bed, protects the integrity of the catalyst. The oxygen, e.g., air, is heated to an elevated temperature prior to contacting the catalyst to oxidize the solid matter. The temperature can vary and, in general, is above the combustion temperature of the solid matter, thereby being effective to burn off the solid matter deposited on the catalyst.

The catalyst regeneration includes contacting the catalyst with nitrogen-rich (e.g., oxygen lean) gas, e.g., air, to burn off carbon and residual organics deposited on the catalyst. In certain embodiments, the nitrogen-rich gas is heated to an elevated temperature, e.g., above the combustion temperature of the solid matter, and contacts the catalyst by passing a stream of the heated nitrogen gas through or over a catalyst bed in a reactor vessel.

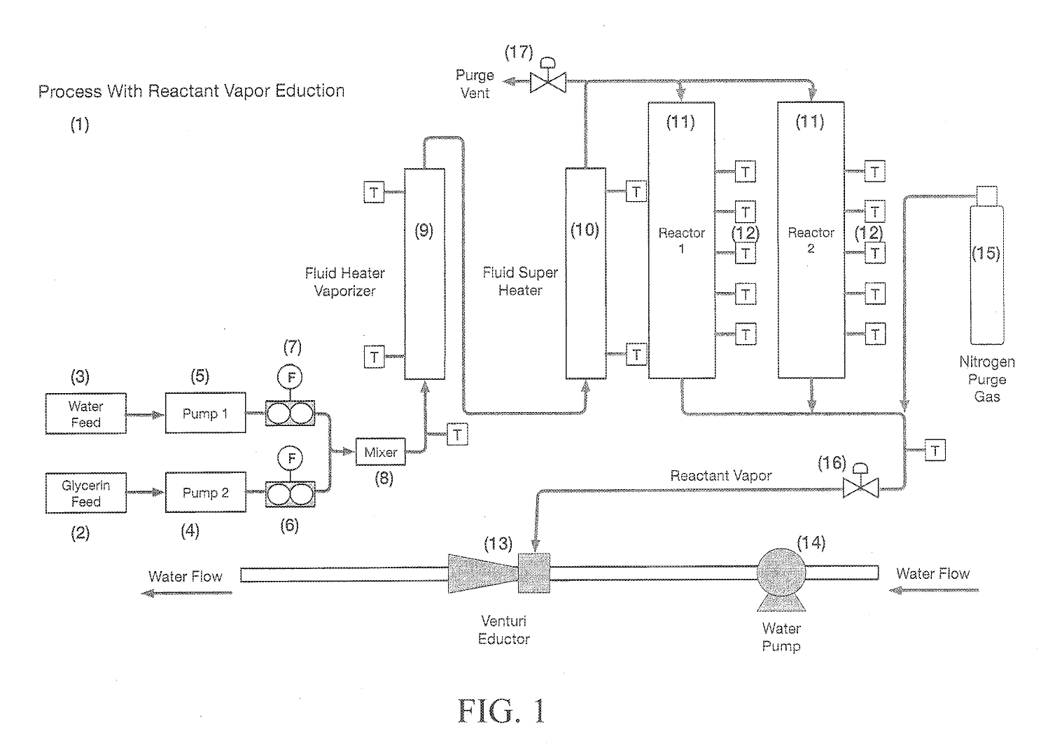

The methods and apparatus of the invention can be employed with a wide variety of chemical systems and reactors. In certain embodiments, the chemical process can include a glycerol-water reaction conducted in a fixed-bed catalyst reactor. In these embodiments (one of which is described in more detail in FIG. 1), conversion of glycerin into, for example, acetal, can generate, in the fixed-bed catalyst reactor, a complex mixture including solid matter in the form of carbon particles and/or coke deposits. Over a period of time, the solid matter, e.g., the carbon particles and/or the coke deposits, can plug catalyst pores and, as a result, reduce catalyst activity in the catalyst bed. The catalyst bed can be regenerated by oxidizing the carbon particles and/or coke deposits and therefore, removing the solid matter as a gas, which can include nitrogen, water, carbon monoxide, carbon dioxide and mixtures thereof. As previously described, the amount of the oxygen can be controlled by nitrogen gas dilution to the temperature increase due to oxidation of the carbon and residual organics, and to protect the integrity of the catalyst during regeneration.

Regeneration of the catalyst bed in the reactor can be conducted as an optional after-reaction process. In this embodiment, during periods on non-operation, a stream of the nitrogen-rich gas, e.g., air, is introduced into the reactor (off-line), passed through the catalyst bed to contact the catalyst, and discharged through an outlet of the reactor. The catalyst bed is regenerated in-place without out being removed from inside of the reactor vessel. In other embodiments, the catalyst bed can be removed from the reactor and transferred to a separate regeneration vessel, wherein the nitrogen-rich gas is introduced into the regeneration vessel to contact and regenerate the catalyst bed.

Some chemical systems require more frequent regeneration. For example, swing reactor systems are used in the processing industry for chemical systems and processes that involve catalyst regeneration on a consistent or frequent basis. This is common practice for fixed-bed catalyst reactors, wherein catalyst regeneration is performed in-situ. For a swing reactor system, having multiple reactors, catalyst regeneration is performed in a first reactor that is non-operational. One or more other reactors are operated while the first reactor is undergoing catalyst regeneration to remove solid matter, e.g., carbon and/or coke deposits, that accumulate on the catalyst during operation of the reactor. Thus, the chemical process swings to a second reactor (or a greater number of multiple reactors), while the catalyst bed in the first reactor is regenerated. Upon completion of the regeneration, the first reactor is operational and one of the other reactors is then rendered non-operational, such that catalyst regeneration is performed on another reactor.

In certain embodiments, the methods and apparatus according to the invention, are employed in a water treatment system as shown in FIG. 1. FIG. 1 is a schematic showing a water treatment system that includes a production system 1 having a glycerin 2 feed and a potable water 3 feed. The glycerin 2 feed and the potable water 3 feed, typically, are stored in separate tanks and, piping or conduit is connected to the tanks to independently deliver the glycerin 2 feed and the potable water 3 feed to positive displacement pumps 4 and 5, respectively. A fluid stream of each of the glycerin 2 and potable water 3 is metered independently using flow measurement instruments 6 and 7, respectively, positioned downstream of the pump discharges. The two streams of liquid 2,3 are combined or commingled downstream of the pump discharges into a single pipe or conduit, and flow into a mixing device 8, e.g., an in-line mixer or static mixing device. A glycerin-water mixture is discharged from the mixing device 8 and flows via piping or conduit into a fluid heater (or thermal) vaporizer 9. In the vaporizer 9, the glycerin-water mixture is heated to a temperature ranging from about 200 ° C. (392° F.) to about 250° C. (482° F.), which creates a saturated stream of glycerin-water vapor at an operating pressure between about 1 atmosphere and about 2 atmosphere. The glycerin-water vapor flows via piping or conduit into a fluid superheater 10 where the vapor stream is heated to a temperature ranging from about 280° C. (536° F.) to about 320° C. (608° F.) to produce a super-heated glycerin-water vapor. The super-heated glycerin-water vapor exits the superheater 10 and flows via a pipe or conduit into an inlet (e.g., top portion) of each of two reactor vessels 11, which are fixed-bed catalyst reactors. FIG. 1 shows two reactor vessels 11, however, it is contemplated that there can be more than two reactor vessels to allow for longer process run times by diverting flow of the super-heated glycerin-water vapor to additional reactor vessels. The fixed-bed catalyst reactor vessels 11 are each fitted with one or more thermocouple temperature measurement devices 12 to record and report the temperature within the reactor vessels 11 in a timely manner. The reactor arrangement shown in FIG. 1 allows for flow to be directed through the two reactor vessels 11 in parallel, however, it is contemplated that the two reactor vessels 11, as well as additional reactor vessels, can be arranged in sequence (or series). Positioned within each of the reactor vessels 11 is a solid substrate of a catalytic material (not shown). The super-heated glycerin-water vapor contacts the catalytic material and reacts thereon to form acetal vapor. The acetal vapor is discharged from an exit (e.g., bottom portion) of each of the reactor vessels 11, and via piping or conduit flows into a vapor—liquid eductor 13 positioned downstream of the reactor vessels 11. The vapor-liquid eductor 13 uses a motive force of a flow of water through the eductor 13. The flow through the eductor 13 creates a negative pressure zone within the eductor body drawing the acetal vapor into the flow of water. The flow of water is provided by water pump 14, which can draw water from a water line, water reservoir, water tank or other source of water (not shown). The vapor-liquid eductor 13 also provides a means whereby the acetal vapor mixes with water to facilitate the quench of hot reactant vapors with the water stream. There is a concentration of acrolein in the water downstream of the vapor-liquid eductor, which can be measured by obtaining and evaluating fluid samples.

As a result of the super-heated glycerin-water vapor contacting the catalytic material in the reactor vessels 11, and forming acetal vapor, a complex mixture of carbon particles and/or coke is deposited on the catalyst bed. Over a period of time, catalyst activity can be reduced due to plugging of the catalyst pores with the carbon particles and/or coke in the reactor vessels 11. The catalyst is regenerated by oxidizing the carbon particles and/or coke, forming a gas, and removing the gas, which can include nitrogen, water, carbon monoxide, carbon dioxide, and mixtures thereof.

The catalyst bed in each of the reactor vessels 11 can be regenerated by placing the reactor vessels 11 in a non-operational (e.g., off-line) or shutdown condition. Following shutdown, the reactor vessels 11 are purged with nitrogen gas provided from a nitrogen purge source 15, which introduces the nitrogen gas into piping or conduit located downstream of the reactor vessels 11. A normally open control valve 16 is actuated, closing off the flow downstream and directing the nitrogen gas to the reactor vessels 11. The nitrogen purge gas enters the discharge (e.g., bottom portion) of the reactor vessels 11, passes upward through the interior of the reactor vessels, contacting the catalyst bed, and exits through the inlet (e.g., top portion) of the reactor vessels 11, and is directed via conduit or piping to a nitrogen purge gas vent 17. The vent 17 is fitted with a normally open control valve, which is actuated at the same time as the control valve 16.

In certain embodiments, the reactor vessels 11 can be periodically regenerated over a run-time interval, e.g., of about 6 to 8 hours, and therefore, the process flow is diverted or can alternate, e.g., swing, between the reactors on a frequent basis, e.g., from one reactor to another reactor, 3 to 5 times per 24-hour operating period. One method of restoring the performance of the catalyst includes regeneration achieved by introducing air (e.g., a nitrogen-rich, oxygen-lean gas) at an appropriate temperature, which is defined as being above the combustion temperature of the particulate matter, thereby burning away the collected particulate matter. The method can also be configured to regenerate the catalyst as an optional after-reaction process, wherein the catalyst is regenerated in place during a non-operation period or removed from the reactor and transferred to a separate regeneration vessel.

Additional objects, advantages and novel features of the invention may become apparent to one of ordinary skill in the art based on the above description and examples, which are provided for illustrative purposes and are not intended to be limiting.

1. A method of regenerating a catalyst bed having catalyst with solid matter deposited thereon, comprising:
heating a nitrogen-rich gas to an elevated temperature to produce a heated nitrogen-rich gas;
passing the heated nitrogen-rich gas through or over the catalyst bed; and
contacting the catalyst with the heated nitrogen-rich gas.

2. The method of claim 1, wherein the nitrogen-rich gas is air.

3. The method of claim 1, wherein the catalyst bed is positioned within a fixed-bed catalyst reactor vessel.

4. The method of claim 3, wherein regenerating the catalyst is conducted without removing the catalyst bed from the reactor vessel.

5. The method of claim 3, wherein the catalyst bed is removed from the reactor vessel for regenerating the catalyst.

6. The method of claim 1, wherein the solid matter deposited on the catalyst is selected from the group consisting of carbon particles, coke deposits, carbon-containing particles, and mixtures thereof.

7. A method of regenerating catalyst, in a catalyst bed, having solid matter deposited thereon and positioned in a reactor, comprising:
introducing a heated nitrogen-rich gas at an inlet of the reactor;
allowing the heated nitrogen-rich gas to flow through an interior of the reactor;
contacting the catalyst in the catalyst bed of the reactor with the heated nitrogen-rich gas; and
discharging the heated nitrogen-rich gas through an outlet of the reactor.

8. The method of claim 7, wherein the nitrogen-rich gas is heated to an elevated temperature prior to being introduced into the reactor.

9. The method of claim 7, further comprising:
dislodging at least a portion of the solid matter from the catalyst; and
subsequently, removing said at least a portion of the solid matter from the reactor.

10. The method of claim 7, wherein the regeneration is conducted with the catalyst bed positioned in the reactor.

11. The method of claim 7, wherein the regeneration is conducted with the catalyst bed removed from the reactor.

12. The method of claim 7, wherein the reactor is a fixed-bed catalyst reactor.
